(19) United States
(12) Patent Application Publication
(10) Pub. No.: US 2011/0037974 A1
(43) Pub. Date: Feb. 17, 2011

(54) PROBE AND DEVICE FOR OPTICALLY TESTING TEST OBJECTS

(76) Inventor: Tobias Gnausch, Mühlhausen (DE)

Correspondence Address: KENYON & KENYON LLP, ONE BROADWAY, NEW YORK, NY, 10004, US

(21) Appl. No.: 12/735,052

(22) PCT Filed: Nov. 28, 2008
(86) PCT No.: PCT/EP2008/066404

§ 371 Date: Oct. 8, 2010

(30) Foreign Application Priority Data
Dec. 12, 2007 (DE) 10 2007 059 903.1

(51) Int. Cl. G02B 27/32

(52) U.S. Cl. 356/247

(57) ABSTRACT

An optical probe for optically testing test objects includes: a stationary probe component and a probe component rotatable about an axis of rotation and mechanically and optically coupled to the stationary probe component, the rotating probe component having at least two optical outputs for coupling out measuring beams, from which the measuring beams of varying focal distances d exit perpendicularly with respect to the axis of rotation.

### BACKGROUND OF THE INVENTION

1. Field of the Invention

The present invention relates to an optical probe for optically testing test objects, and to a device for interferometric measurement of test objects using the probe.

2. Description of Related Art

In the industrial manufacture of components, for example, it is known to test the components optically during or following the manufacturing process. For this purpose, the surfaces of the components are illuminated by an optical probe and a usable image of the surface is obtained. In this connection, one also speaks of “optical scanning” and describes the probe as a “scanning arm”.

In particular, optical probes have also been used which are divided into a stationary and a rotating probe component. Such a device is described in published German patent document DE 100 57 540 A1 for example. According to the teaching in the document, such a device allows for a relatively simple alignment for scanning the test object and a design of the probe component for a precise rotating scan. Thus it is possible to scan e.g. a very narrow bore of an injection nozzle from inside using a rotating probe component. Advantageously, the test object itself thus does not have to be rotated. If multiple components having e.g. different bore diameters are to be measured, however, it is not possible to test all components using a single probe described in the teaching since the focal length of the probe is set to a fixed value. The same problem arises when a component is to be measured in different places of varying diameter.

By contrast, another device for optically testing a surface is known from published German patent document DE 197 14 202 A1, in which the object to be tested may be illuminated in two different places simultaneously using two measuring beams. In particular, in one exemplary embodiment, two measuring beams not running in parallel to each other make it possible to illuminate the test object at the same time perpendicularly in two places that are not in one plane. This probe thus offers two different directions of view. A rotating probe component is not provided for this purpose.

The known optical probes therefore do not make it possible to measure components having different inner diameters using only one probe. In particular, even when measuring only one component it is unfortunately necessary to exchange a probe, and to adjust the new probe, if the one component has different inner diameters in several places.

### BRIEF SUMMARY OF THE INVENTION

The optical probe according to the present invention, or the device according to the present invention having the probe, advantageously allows for the probe to be used very flexibly. Advantageously, the probe according to the present invention does not have to be exchanged even in the case of multiple measurements of different inner diameters.

Consequently, this eliminates the necessity of having to use a new probe and adjust the new probe when the distance of the test surface to be measured changes with respect to the probe. Advantageous further developments of the present invention are delineated in the dependent claims and described in the specification.

### BRIEF DESCRIPTION OF THE DRAWINGS

FIG. 1 shows a probe known from the related art.

FIG. 1a shows a detail from FIG. 1.

FIG. 2 shows an exemplary embodiment of the probe according to the present invention.

FIG. 2a shows a detail from FIG. 2.

### DETAILED DESCRIPTION OF THE INVENTION

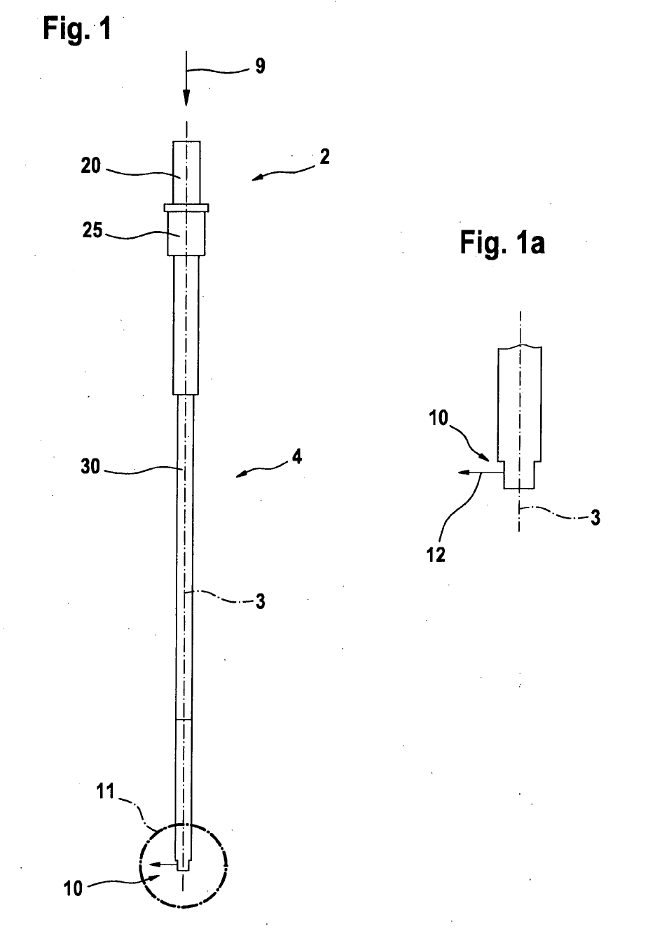

FIG. 1 shows an optical probe 2 known from the related art. Probe 2 has a stationary probe component and a rotating probe component 4 that is mechanically and optically coupled to the stationary probe component. For reasons of clarity, FIG. 1 only shows rotating probe component 4. Beams 9 are supplied to rotating probe component 4 by the stationary probe component that is not shown in the drawing. The beams are guided onward via optical elements 30 to an optical output 10 in an output region 11.

Rotating probe component 4 is connected to the stationary probe component via a ferrule 20. A sleeve 25 holds ferrule 20 and optical elements 30 stably together to form a probe component 4. Output region 11 of probe 2 is enlarged in FIG. 1a. In particular, it can be seen that only one optical output 10 is provided for illuminating the test object. For better understanding, FIG. 1a schematically shows a focused measuring beam 12, which exits probe 2 perpendicularly with respect to an axis of rotation 3.

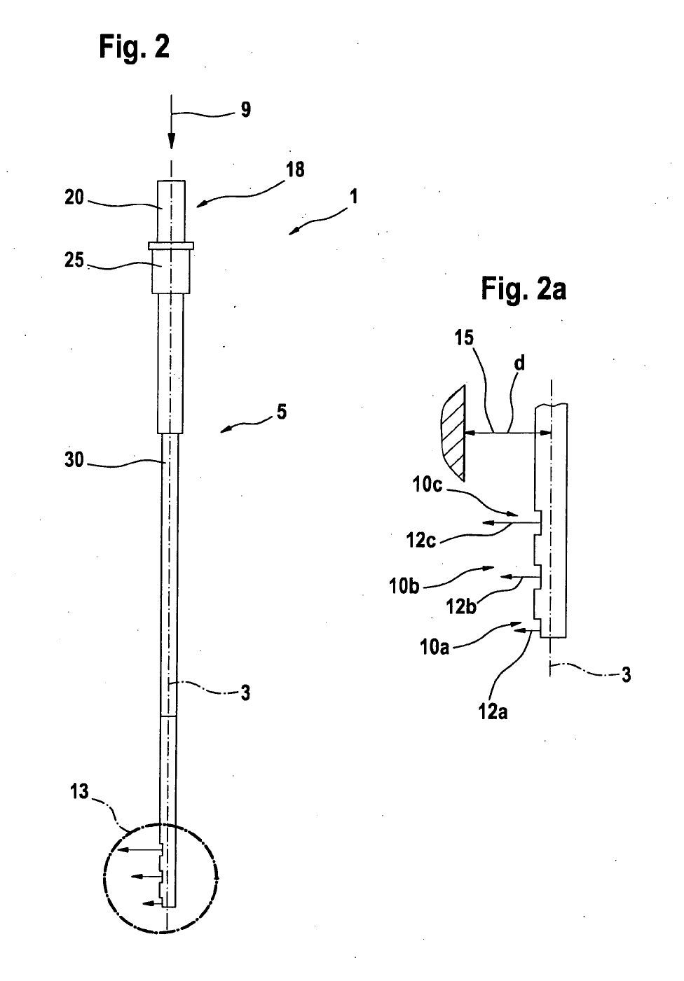

In comparison, FIGS. 2 and 2a show an exemplary embodiment of a probe 1 according to the present invention for optically testing test objects. It comprises a stationary probe component, also not shown in the drawing, and a probe component 5, which is rotatable about an axis of rotation 3 and is mechanically and optically coupled to the stationary probe component, rotating probe component 5 comprising at least two optical outputs 10a; 10b; 10c for coupling out measuring beams, from which the measuring beams, having different focal distances d, exit perpendicularly with respect to axis of rotation 3.

FIG. 2a shows output region 13 in an enlarged view such that the plurality of outputs 10a; 10b; 10c are clearly visible. Three outputs 10a; 10b; 10c are shown here in exemplary fashion, focused measuring beams 12a; 12b; 12c having varying lengths or focal distances d. A focal distance d, indicated in FIG. 2a by reference number 15, is understood as the distance between axis of rotation 3 of rotating probe component 5 and the focal point of a focused measuring beam 12a; 12b; 12c. In our examples, axis of rotation 3 is at the same time the axis of symmetry of rotating probe component 5. In the ideal case, the focal point of the measuring beam strikes the surface of the test object precisely.

Now it is advantageously also possible to measure bores of different diameters from inside using only one probe 1, or one rotating probe component 5, since multiple outputs having different focal distances d are provided.

As shown in FIG. 2a, there is a further provision of positioning optical outputs 10a; 10b; 10c along axis of rotation 3 ordered according to their different focal distances d 15. In this example, the outputs are arranged according to decreasing focal distances toward the end of the probe. Thus it is possible to determine the correct output for a concrete existing bore diameter quickly and systematically.

Rotating probe component 5 is connected to the stationary probe component via a coupling point 18. Via this coupling point 18, beams 9 are supplied from the stationary probe component (not shown) to rotating probe component 5. Coupling point 18 is advantageously developed as a ferrule 20 on rotating probe component 5. This ferrule 20 advantageously has a glass fiber running through it, into which beams 9 are coupled. If required, e.g. in the case of damage to rotating probe component 5, rotating probe component 5 may thus be exchanged quickly. In practice, a ferrule 20 having a thickness of 2.5 mm is used for example.

Furthermore, rotating probe component 5 comprises a sleeve 25, which holds ferrule 20 and optical components 30 together or stabilizes them. This yields a compact and at the same time robust assemblage. These optical components 30 are used to focus and/or to deflect the measuring beam and may be additionally protected and additionally stabilized by one or more metal tubes.

Regardless of whether or not coupling point 18 is developed as a sleeve 25, coupling point 18 may also be implemented as a swivel coupling. It is particularly advantageous if the swivel coupling is provided in the form of an optical waveguide swivel coupling.

So as to deflect the measuring beams correctly from the rotating probe component 5 to the perpendicular illumination of the test object, a deflection optics is required in the beam path of the measuring beams. An exemplary embodiment is provided, in which for each optical output 10a; 10b; 10c of the at least two optical outputs 10a; 10b; 10c, a separate deflection optics is situated in rotating probe component 5. This makes it easier to adjust the focal distance d precisely for each individual optical output 10a; 10b; 10c. For this purpose, each deflection optics comprises exactly one prism. The deflection optics may be situated in series along axis of rotation 3. For this purpose, it is important that these be aligned very precisely with respect to one another in order to achieve the desired focal distances d. Beams 9 striking the deflection optics are partially deflected to the respective outputs 10a; 10b; 10c and are partially guided straight ahead to the next deflection optics. The deflection optics are thus partially previous and partially deflecting.

In another example embodiment, a switching device is provided in probe 1 for switching individual optical outputs 10a; 10b; 10c on or off independently. The user is thus advantageously able to activate or deactivate specific outputs.

The measuring beam reflected on the surface of the test object is taken up again by probe 1 or rotating probe component 5. The reflected measuring beam now typically runs through the previously traveled beam path in the opposite direction, i.e. on output 10a; 10b; 10c of probe 1 it is reintroduced into rotating probe part 5 and exits rotating probe part 5 at coupling point 18. The term “output” refers, as familiar to one skilled in the art, not to the measuring beam reflected by the test object. The measuring beam again guided out of probe 1 as a whole is then supplied to a detection unit, to which an evaluation unit is connected. This makes it possible to analyze the test objects illuminated by probe 1.

All of the example embodiments of probe 1 described so far are suitable for being connected to an interferometer known per se. Together these then form a device for the interferometric measurement of test objects. Ideally, the interferometer is connected to probe 1 via an optical fiber. The structure of a typical interferometer is not explained further since this was already described in detail, e.g., in published German patent document DE 100 57 540 A1 cited at the outset. It should be emphasized nevertheless that the interferometer may also include an evaluation unit in addition to the detection unit. In summary, an optical probe 1 having a stationary probe component and a rotating probe component 5 has been described, which may be used to measure a greater spectrum of components having different bore diameters. For this purpose, at least two optical outputs 10a; 10b; 10c for coupling out measuring beams are provided in rotating probe component 5, from which the measuring beams of different focal distances d 15 exit perpendicularly with respect to axis of rotation 3 of rotating probe component 5. Furthermore, a device has been provided, which comprises an interferometer known per se and the described probe 1. Altogether, this yields an optical probe 1 that may be used in very many ways in different test objects.

1-10. (canceled)

11. An optical probe for optically testing test objects, comprising:
a stationary probe component; and
a rotating probe component rotatable about an axis of rotation and coupled mechanically and optically to the stationary probe component, wherein the rotating probe component comprises at least two optical outputs for coupling out measuring beams of varying focal distances, and wherein the measuring beams exit perpendicularly with respect to axis of rotation.

12. The probe as recited in claim 11, wherein the optical outputs are positioned along the axis of rotation in an order according to the different focal distances.

13. The probe as recited in claim 11, wherein the rotating probe component is connected to the stationary probe component via a coupling point.

14. The probe as recited in claim 13, wherein the coupling point is configured as a ferrule on the rotating probe component.

15. The probe as recited in claim 13, wherein the coupling point is configured as a swivel coupling.

16. The probe as recited in claim 14, wherein the rotating probe component comprises a sleeve holding the ferrule and optical components together.

17. The probe as recited in claim 11, wherein for each optical output of the at least two optical outputs, a separate deflection optics is situated in the rotating probe component.

18. The probe as recited in claim 17, wherein the two deflection optics are situated in series along the axis of rotation.

19. The probe as recited in claim 11, further comprising:
a switching device configured to switch individual optical outputs on and off independently.

20. A device for interferometric measurement of test objects, comprising:
an optical probe for optically testing test objects, including:
a stationary probe component; and
a rotating probe component rotatable about an axis of rotation and coupled mechanically and optically to the stationary probe component, wherein the rotating probe component comprises at least two optical outputs for coupling out measuring beams of varying focal distances, and wherein the measuring beams exit perpendicularly with respect to axis of rotation; and
an interferometer connected to the optical probe.
